(19) United States
(12) Patent Application Publication
(10) Pub. No.: US 2017/0325089 A1
(43) Pub. Date: Nov. 9, 2017

(54) METHOD AND SYSTEM OF USER AUTHENTICATION AND END TO END ENCRYPTION USING DEVICE SYNCHRONIZATION

(71) Applicants: Praneet Sharma, BERKELEY, CA (US); James Braden Munch, Lafayette, CA (US)

(72) Inventors: Praneet Sharma, BERKELEY, CA (US); James Braden Munch, Lafayette, CA (US)

(21) Appl. No.: 15/430,522

(22) Filed: Feb. 12, 2017

Related U.S. Application Data
(60) Provisional application No. 62/331,361, filed on May 3, 2016.
(60) Provisional application No. 62/378,210, filed on Aug. 22, 2016.

(51) Int. Cl. H04W 12/06; H04L 29/06; H04W 12/04

(52) U.S. Cl. CPC H04W 12/06; H04W 12/04; H04L 63/0876; H04L 63/0428; H04L 63/06; H04L 2209/80

(57) ABSTRACT

In one aspect, a computerized method for implementing user authentication using, device synchronization to match that includes the step of accessing a web page. The web page includes an agent. The computerized method includes the step of loading the agent in the background. The computerized method, includes the step of, generating, with the agent, an agent-generated token in background. The agent-generated token is encrypted as a cryptographic token. The computerized method includes the step of executing a deep link with the agent-generated token. The computerized method includes the step of sending the agent-generated token, a Universally unique identifier (UUID) and a private key in a hidden native application to an encrypted-token server. The computerized method includes the step of determining that the IP address pairs with the agent-generated token. The computerized method includes the step of receiving, with the native application, a call back. The computerized method includes the step of sending the UUID and the agent-generated token back to the encryption server. The computerized method includes the step of receiving, with the encryption server, the UUID and the agent-generated token. The computerized method includes the step of checking, with the encryption server, that the UUID and the agent-generated token point to same UUID. The computerized method includes the step of determining that the UUID and the agent-generated token point to same UUID.

### CROSS-REFERENCE TO RELATED APPLICATIONS

This application is a claims priority from U.S. Provisional Patent Application No. 62/331,361, filed on May 3, 2016. This application is a claims priority from U.S. Provisional Patent Application No. 62/378,210, filed on Aug. 22, 2016. These applications are hereby incorporated by reference in their entirety.

### FIELD OF THE INVENTION

The invention is in the user authentication and more specifically to a method, system and apparatus of a user authentication using device synchronization to snatch.

### DESCRIPTION OF THE RELATED ART

It is noted that certain data breaches could be prevented by confining users sessions to a known device or series of known devices. Additionally, the current art can benefit from a means to establish a framework that continuously monitors these on one-to-one (1:1) relationships between users and their sessions in an effort to terminate high risk or duplications sessions.

### BRIEF SUMMARY OF THE INVENTION

In one aspect, a computerized method for implementing user authentication using device synchronization to match that includes the step of accessing a web page. The web page includes an agent. The computerized method includes the step of loading the agent in the background. The computerized method includes the step of generating, with the agent, an agent-generated token in background. The agent-generated token is encrypted as a cryptographic token. The computerized method includes the step of executing a deep link with the agent-generated token. The computerized method includes the step of sending the agent-generated token, a Universally unique identifier (UUID) and a private key in a hidden native application to an encrypted-token server. The computerized method includes the step of determining that the IP address pairs with the agent-generated token. The computerized method includes the step of receiving, with the native application, a call back. The computerized method includes the step of sending the UUID and the agent-generated token back to the encryption server. The computerized method includes the step of receiving, with the encryption server, the UUID and the agent-generated token. The computerized method includes the step of checking, with the encryption server, that the UUID and the agent-generated token point to same UUID. The computerized method includes the step of determining that the UUID and the agent-generated token point to same UUID.

Optionally, the computing device can be a mobile device. The agent can include a JavaScript file. The agent-generated token can be an encrypted as a pseudo-random number/character string. Deep linking can include the use of a hyperlink that links to a specified searchable and indexed piece of web content on a website and not the website's home page. The hidden native application can be installed and operating in the computing device, and the deep linking trigger the opening of the hidden native application.

### BRIEF DESCRIPTION OF THE DRAWINGS

FIG. 1 illustrates an example process for implementing user authentication using device synchronization to match, according to some embodiments.

FIG. 2 illustrates an example process for implanting a UUID/encrypted key pairing currently associated with a user machine using an HTTP cookie, according to some embodiments.

FIG. 3 illustrates another example process for implementing user authentication using device synchronization to match, according to some embodiments.)

FIG. 4 illustrates an example process for implementing user authentication using device synchronization to match in a VPN-type context, according to some embodiments.

FIG. 5 illustrates an example process for verifying a current encrypted token/UUID pairing in a VPN-type context, according to some embodiments.

FIG. 6 depicts an exemplary computing system that can be configured to perform any one of the processes provided herein.

FIG. 7 is a block diagram of a sample computing environment that can be utilized to implement various embodiments.

FIGS. 8A-B illustrates an example process for implementing user authentication using device synchronization to match, according to some embodiments.

FIG. 9 illustrates an example process automatically generating passive-authentication applications according to some embodiments.

FIG. 10 illustrates example system of an encryption server, according to some embodiments.

The Figures described above representative set, and are not an exhaustive with respect to embodying the invention.

### DESCRIPTION

Disclosed are a system, method, and article of manufacture of passive-user authentication and end to end encryption. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Dependency injection can be a software design pattern that implements inversion of control for resolving dependencies. A dependency can be an object used as a service. An injection can be the passing of a dependency to a dependent object (e.g. a client) that would use it. The service can be made part of the client's state.

Domain addresses can share a common suffix (e.g. google.com, facebook.com, etc.). A subdomain (e.g. something.google.com, etc.) can be under that root domain. In some examples, data in iframes and cookies can be restricted by domain. Accordingly, other code running on the page cannot maliciously access that data.

HTTP cookie can be a small piece of data sent from a website and stored in the user's web browser.

Network socket (e.g. ‘socket’) can be an end-point in a communication across a network or the internet. Example sockets can include a TCP socket.

Session can be a semi-permanent interactive information interchange between two or more communicating devices such as between a computer and user (i.e. a user's computing device). A session can be established at a certain point in time, and then torn down at some later point. An established communication session may involve more than one message in each direction.

Session token (a ‘token) can be a unique identifier of an interaction session.

Secure Sockets Layer (SSL) can be a cryptographic protocol.

Software agent (e.g. an ‘agent’) can be a piece of software that acts on, or in conjunction with another, usually parent, program and monitors its data, processes and can trigger events and actions on, the parent program's behalf.

Universally unique identifier (UUID) can be an identifier standard used in software construction. The UUID can be a 128-bit value.

Uniform Resource Locator (URL) can be a reference to a web resource that specifies its location on a computer network and a mechanism for retrieving it.

Window can be, display rectangle used by a graphical user interface.

Virtual private network (VPN) can extend a private network across a public network, such as the Internet. It can enable users to send and receive data across shared or public networks as if their computing devices were directly connected to the private network.

### EXAMPLE METHODS AND PROCESSES

In some embodiments a passive-user authentication process can be implemented. The process can manage user-device restrictions and utilize unique credentials. The process can provide an extra factor of authentication to other user-authentication methods. The process can monitor a session and manage session synchronization.

In, one example, the user device can include a passive-user authentication application that implements the user-side of the passive-user authentication process. The passive-user authentication application can operate in the background. The passive-user authentication application can generate a UUID. The passive-user authentication application can contact an encrypted-token server. The encrypted-token server can implement the server-side aspects of the passive-user authentication process. The encrypted-token server can generate an encrypted token for the UUID sent by the, background application. The passive-user authentication application can automatically open a browser window. The passive-user authentication can store a cookie with an encrypted UUID and token pair. The passive-user authentication application can then close the window after a specified period (e.g. after one-hundred milliseconds, after half a second, after one second, etc.). The code snippet can contact the passive-user authentication server. The passive-user authentication server can maintain a list of paired UUID and tokens. The passive-user authentication server can log the UUID's and encrypted token pairings. The passive-user authentication server can push encrypted tokens to the user-side device at specified intervals (e.g. every few seconds, every second, etc.). The passive-user authentication server can check if the UUID matches matched token. Server then either pairs new UUID to User ID or validates if UUID matches User ID. If the validation is successful, the passive-user authentication server can log the synchronization event. In some examples, the passive-user authentication process can be implemented at an authentication event and/or throughout (e.g. at specified periods and/or events) the session. In one example, a user can visit a domain with a passive-user authentication sandbox snippet (e.g., can comprises a single line of software code, etc.) installed. The snippet can cause the user-side device to check the identification and obtain a user identifier for the current domain. This can be implemented the background.

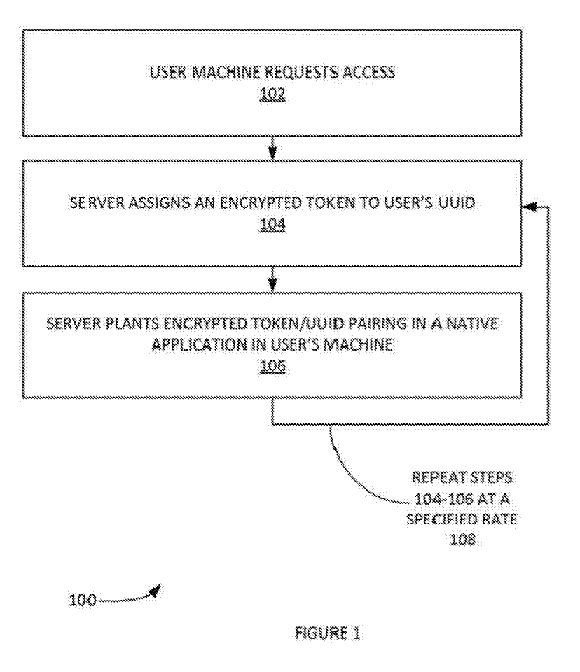

FIG. 1 illustrates an example process 10 for, implementing user authentication using device synchronization to match, according to some embodiments. In step 102, a user machine (e.g. a user's computing system) can request access. For example, the user machine can request access to a particular domain(s), web page(s), data set(s), etc. The request can be made to a server. The user's machine can pass a UUID (and/or other unique identifier). In step 104, a server (e.g. passive-user authentication server, etc.) can generate a token (e.g. an encrypted token). The token can be matched to the UUID. The server can maintain an index of various UUID's and their paired encrypted tokens. IN step 105, the server can implant the UUID/encrypted key pairing currently associated with user machine in a native application (e.g. a background application such the passive-user authentication application provided supra, etc.). Optionally, in step 108, steps 104 and 106 can be repeated, at a specified rate (and/or when specified triggers are detected). In this way, the server can update the UUID/encrypted key pairing currently associated with user machine. The UUID/encrypted key pairing currently associated with user machine can be used to passively authenticate the user's machine in various contexts (e.g. when the user requests a new web page, at a specified period, etc.).

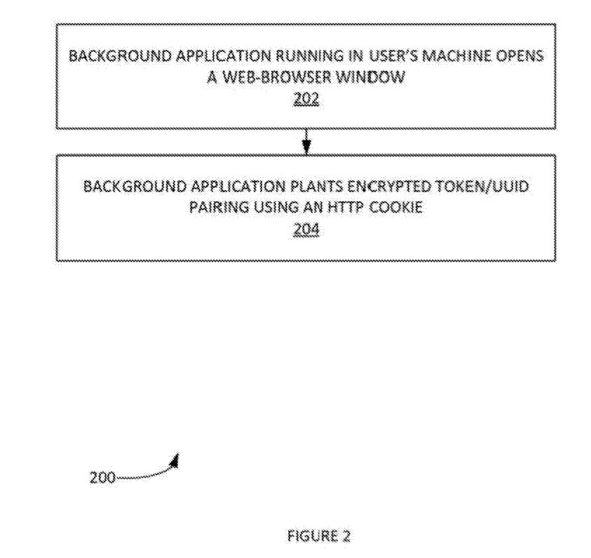

FIG. 2 illustrates an example process 200 for implanting a UUID/encrypted key pairing currently associated with a user machine using an HTTP cookie (e.g., a ‘cookie’). In one example, the HTTP cookie including the UUID/encrypted key pairing currently associated with user machine can be implanted in a web browser operating in the, user machine. More particularly, in step 202, a background application (e.g. a user authentication using device synchronization to match application) running in the user machine can open a web-browser window. It is noted that the web-browser window can be another type of window (e.g. an application-specific window type, etc.) In other example embodiments. The window can be open for a specified period of time and need not be visible to the user on a graphical display of the user's machine. In one example, the window can be opened for 300 milliseconds. However, other time intervals can be utilized in other examples. In step 204, the background application can implant the UUID/encrypted key pair in an HTTP cookie in the window. In other contexts, other entities similar to HTTP cookies can be utilized.

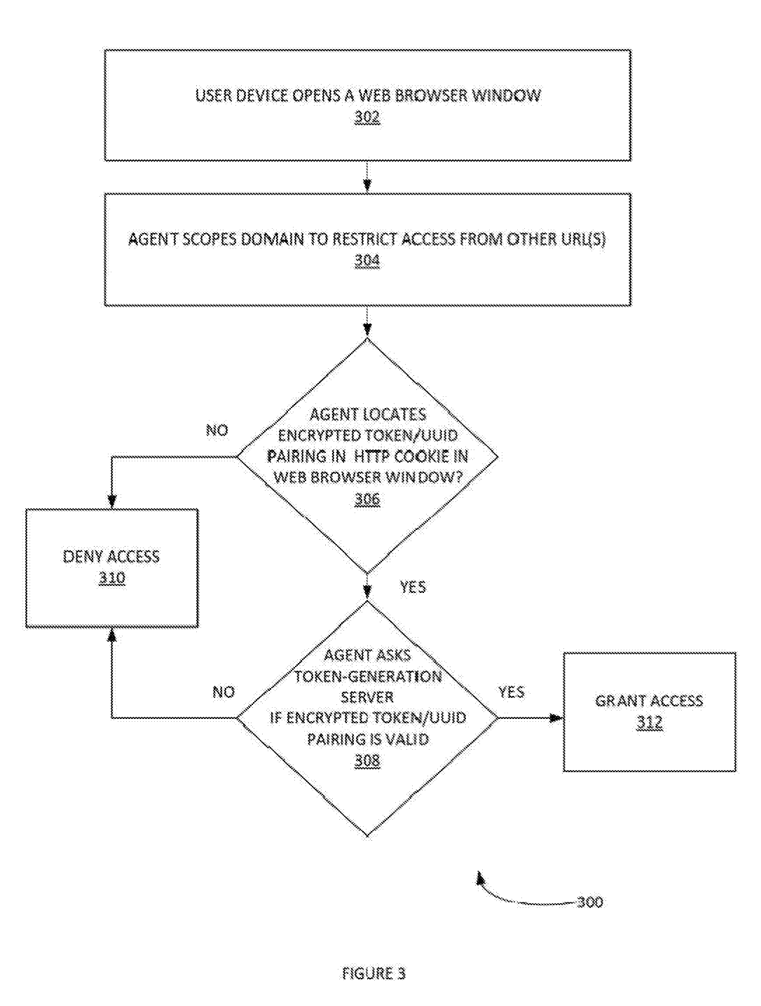

FIG. 3 illustrates another example process 300 for implementing user authentication using device synchronization to match, according to some embodiments. In step 302, a user device can open a web-browser window. In step 304, an agent is scoped by domain to restrict access from other code running on parent program. In step 306, it can be determined if the agent detects an encrypted token/UUID pairing in an HTTP cookie in the web-browser. If ‘yes’, process 300 can proceed to step 308. If ‘no’, process 300 can proceed to step 310. In step 310, process 300 can deny access. In step 308, the agent can ask a user authentication using device synchronization to match server to determine if the present encrypted token/UUID pairing is valid. For example, the user authentication using device synchronization to match server can maintain a list of currently valid encrypted token/UUID pairs, If ‘no’, process 300 can proceed to step 310. In step 310, process 300 can deny access. If ‘yes’, process 300 can proceed to step 312. In step 312, process 300 can grant access.

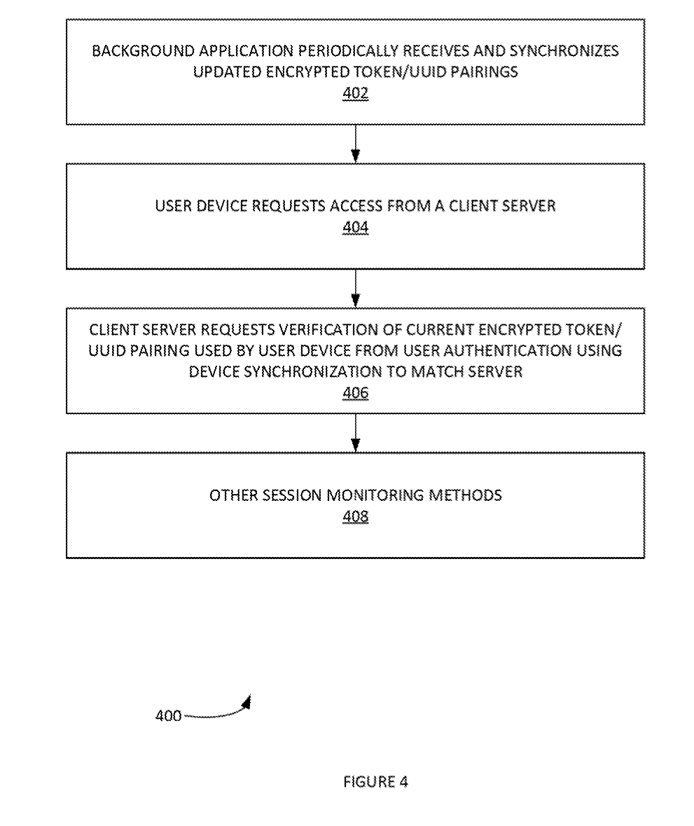

FIG. 4 illustrates an example process 400 for implementing user authentication using device synchronization to match in a VPN-type context, according to some embodiments. In step 402, a background application can periodically receive and synchronize updated, encrypted token/UUID pairings. In step 404, the user device can request access from a client server. In step 406, the client server can request verification of current encrypted token/UUID pairing used by user device from passive-authentication server. In step 406, other session monitoring methods by process 400.

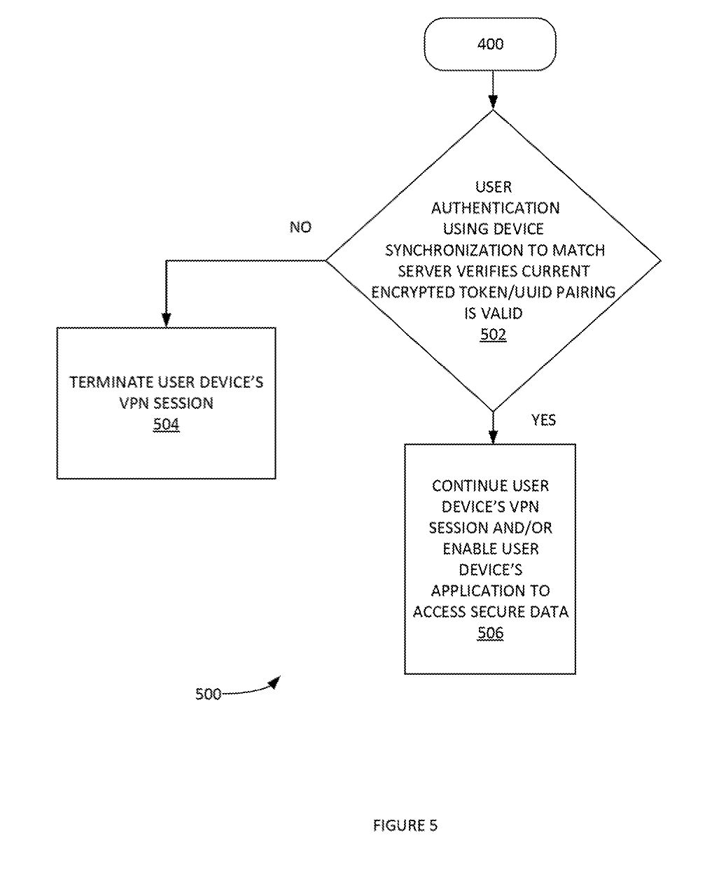

FIG. 5 illustrates an example process 500 for verifying a current encrypted token/UUID pairing in a VPN-type context, according to some embodiments. A passive authentication server can verify if a current encrypted token/UUID pairing is valid in step 502. If ‘no’, then, in step 504, process 500 can terminate user device's VPN-type session. If ‘yes, then process 500 can continue user device's VPN-type (e.g. VPN-style) session and/or enable user device's application to access secure data in step 506.

### ADDITIONAL EXEMPLARY COMPUTER ARCHITECTURE AND SYSTEMS

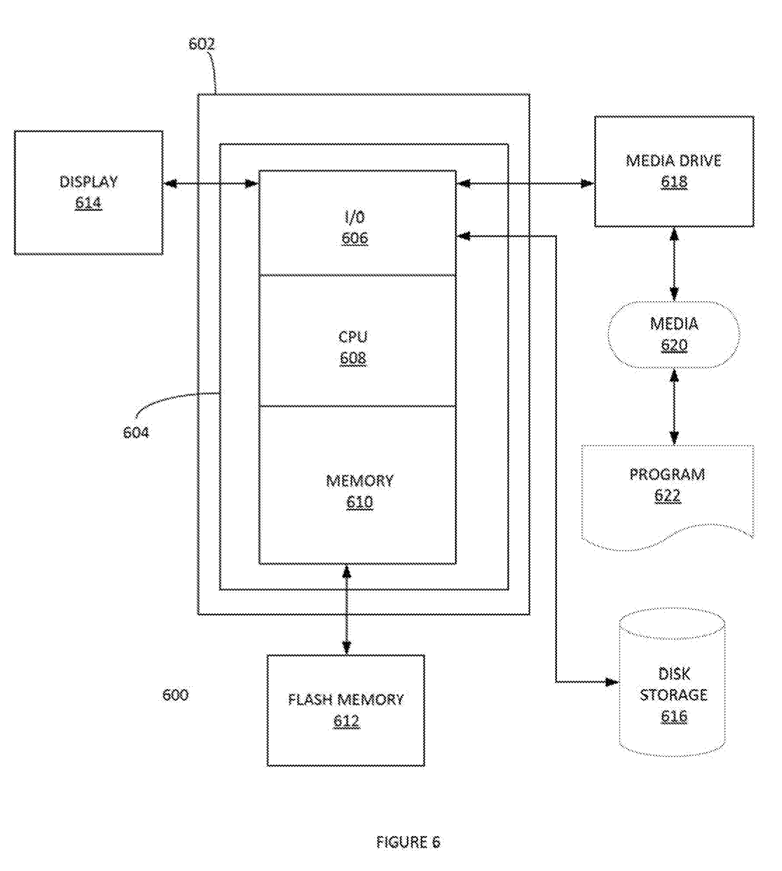

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth (and/or other standards for exchanging data over short distances includes those using short-wavelength radio transmissions), USB, Ethernet, cellular, an ultrasonic local area communication protocol, etc.

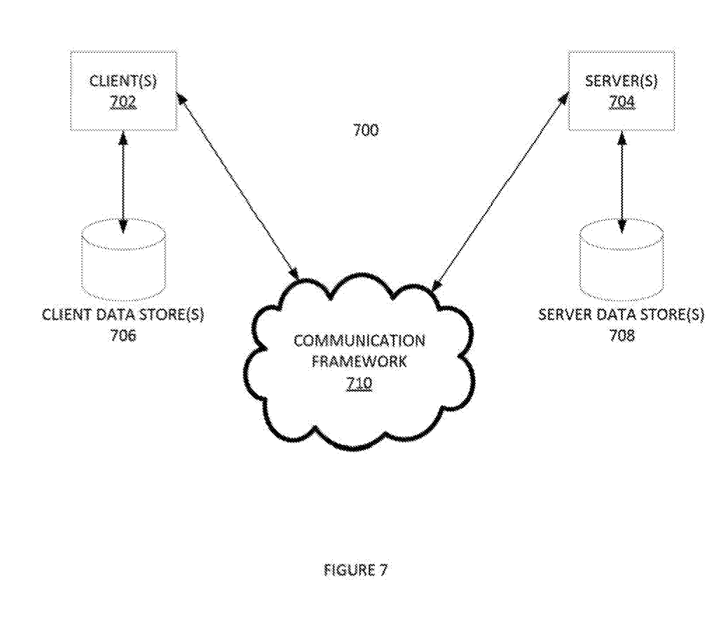

FIG. 7 is a block diagram of a sample computing environment 700 that can be utilized to implement various embodiments. The system 700 further illustrates a system that includes one or more client(s) 702. The client(s) 702 can be hardware and/or software (e.g., threads, processes, computing devices). The system 700 also includes one or more server(s) 704. The server(s) 704 can also be hardware and/or software (e.g., threads, processes, computing devices). One possible communication between a client 702 and a server 704 may be in the form of a data packet adapted to be transmitted between two or more computer processes. The system 700 includes a communication framework 710 that can be employed to facilitate communications between the client(s) 702 and the server(s) 704. The client(s) 702 are connected to one or more client data store(s) 706 that can be employed to store information local to the client(s) 702. Similarly, the servers) 704 are connected to one or more server data store(s) 708 that can be employed to store information local to the server(s) 704. In some embodiments, system 700 can instead be a collection of remote computing services constituting a cloud-computing platform.

### ADDITIONAL EMBODIMENTS

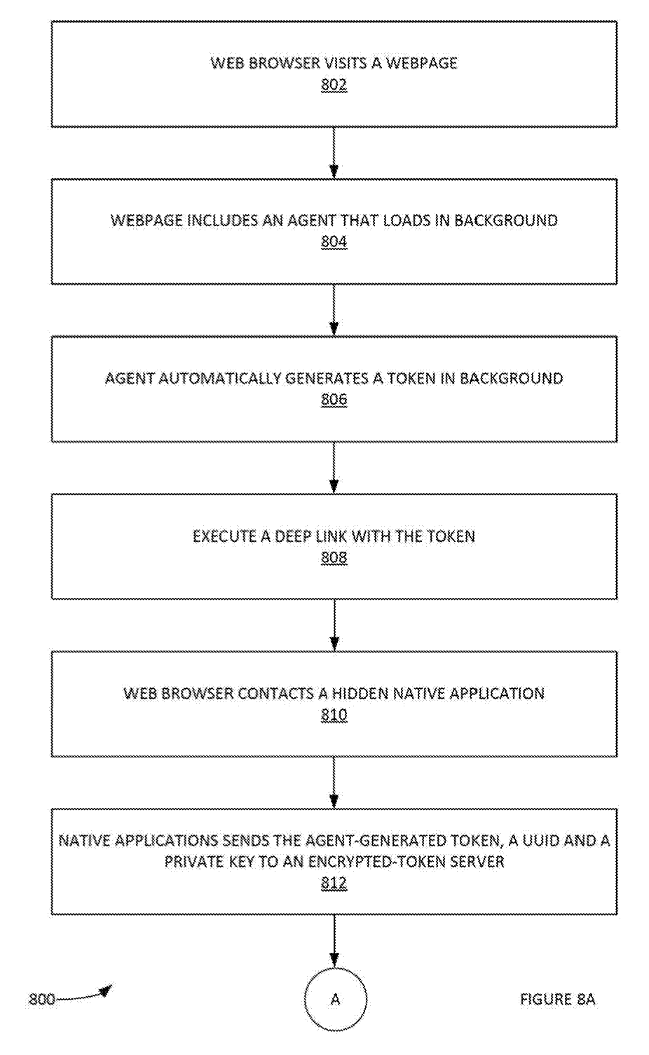

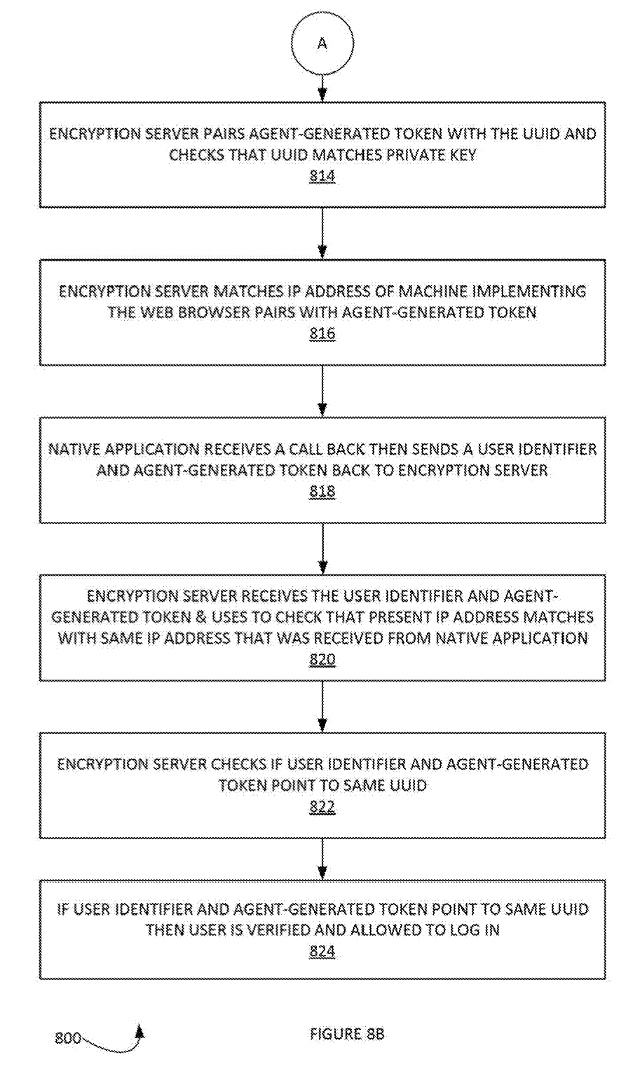

FIGS. 8A-B illustrates an example process 800 for implementing user authentication using device synchronization to match, according to some embodiments. In step 802, a web browser of the user's computing device can access a webpage. The user's computing device can be a mobile device.

In step 804, the accessed webpage can include an agent that loads in the background. The agent can be a JavaScript file, etc. In step 806, the agent can automatically generate an agent-generated token in background. The agent-generated token can be encrypted (e.g. a cryptographic token), a pseudo-random number/character string, etc.

In step 808, process 800 can execute a deep link with the agent-generated token. Deep lining can include the use of a hyperlink that links to a specific, generally searchable or indexed, piece of web content on a website (e.g., “http://example.com/path/page”), rather than the website's home page (e.g., http://example.com/).

In step 810, the web browser can contact a hidden (e.g. from a user's, perspective) native application. The native application can be installed and operating in the user's computing device (e.g. a hidden mobile device application). The deep linking can trigger the opening of the native application of step 810. For example, the web browser can request that the operating system of the user's computing device open the hidden native application. Once the native application is opened, the web browser can pass it the agent-generated token.

In step 812, the native application can send the agent-generated token, a UUID and a private key in the application to an encrypted-token server. The UUID can be embedded in the native application. The UUID can be public.

In step 814, the encryption server can pair the agent-generated token with the UUID. The encryption server can check that the UUID matches the private key. In step 816, the encryption server can match the Internet Protocol (IP) address of user's computing machine implementing the web browser and determine that it pairs with the agent-generated token.

In step 818, the native application can receive a call back and then send UUID and the agent-generated token back to the encryption server. In step 820, the encryption server can receive the user identifier and agent-generated token. The encryption server can use this to check that present IP address matches with same IP address that was received from the native application earlier in process 800. In step 822, the encryption server can check if user identifier and agent-generated token point to same UUID. In step 824, if the user identifier and the agent-generated token point to same UUID, then user is verified and allowed to log in.

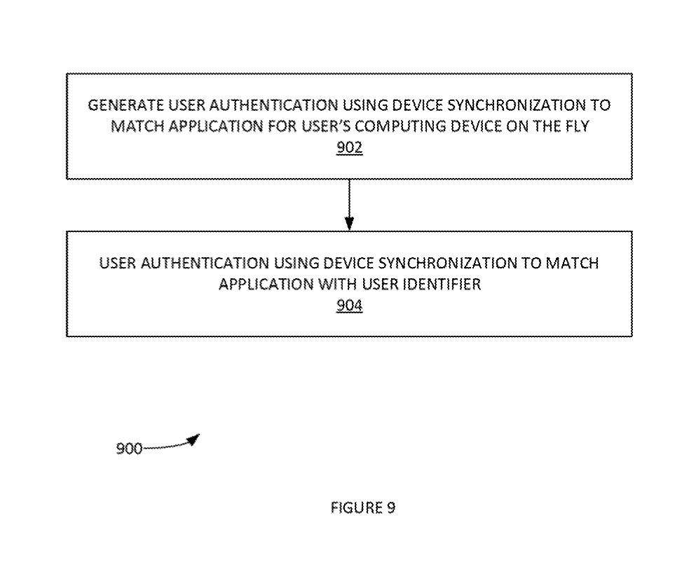

FIG. 9 illustrates n example process 900 automatically generating passive-authentication applications, according to some embodiments. Process 900 can pair the user identifier and UUID prior to the implementation of process 800. In step 902, process 900 can generate a passive-authentication application for a user's computing device on the fly. In step 904, process 900 can pair the passive-authentication application with a user identifier (e.g. the user's email address, etc.). For example, after the pairing process 900 can then distribute to said email address (e.g. to an encryption server, etc.).

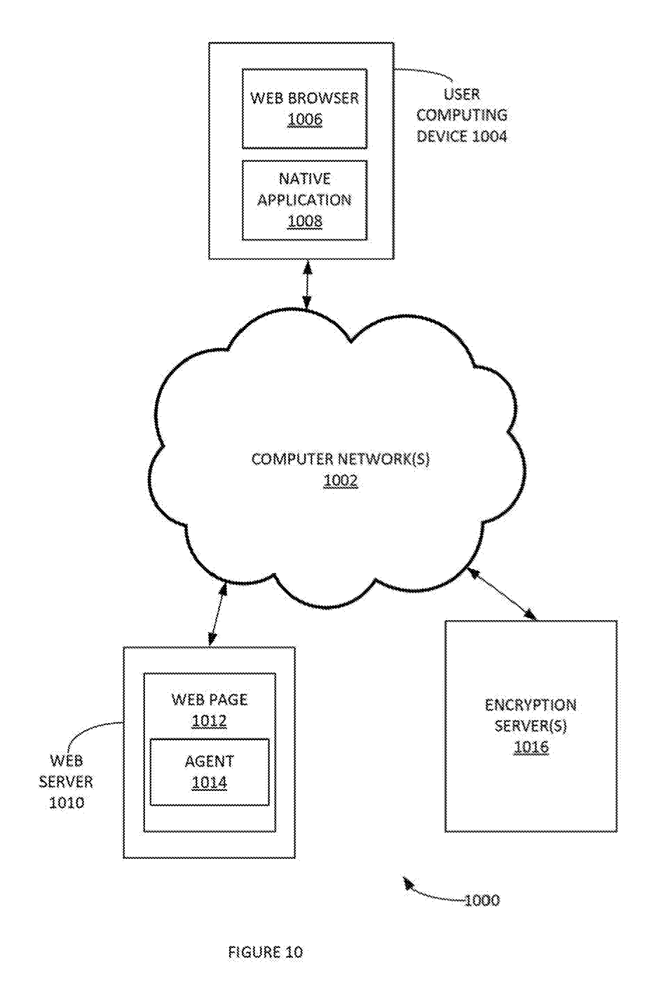

FIG. 10 illustrates an example system 1000 of an encryption server, according to some embodiments. System 1000 can include computer network(s) 1002. Computer network(s) 1002 can include the Internet, cellular data networks, local area networks, enterprise networks etc. User computing-device 1004 can communicate with web server 1010 and/or encryption server 1016 via computer networks 1002.

User computing-device 1004 can include web browser 1006. User computing device 1004 can include an application 1008 for implementing the client-side steps of passive authentication processes provided herein (e.g. processes 100-500 and/or 800, etc.). Application 1008 can be a passive-authentication application. Application 1008 can be hidden from the user's perspective. Web browser 1006 can enable user computing-device 1004 to obtain web-page document 1012 from web server 1010. Web-page document 1012 can include agent 1014. Agent 1014 can automatically generate an agent-generated token in background when web browser 1006 receives web-page document 1012. The agent-generated token can be encrypted (e.g. a cryptographic token), a pseudo-random number/character string, etc.

Encryption servers) 1016 can be used to authenticate the user of user-computing device 1004. For example, encryption server(s) 1016 can implement any of the server-side steps for user authentication using device synchronization to match provided herein (e.g. processes 100-500, 800, etc.).

It is noted that an agent can be a library, code, and/or child application that responds to events from data from, or interaction with a parent application. A background (e.g. a background process, etc.) can be a computer process that runs without an interface and without user intervention. A deep link can be a uniform resource identifier (URI) string that initializes, and initiates an action in another application. It is noted that implementing user authentication using device synchronization to match can include the step of accessing a web page with a web browser of a computing device, an application functionality, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations).

Accordingly,the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is;:

1. A computerized method for implementing user authentication using device synchronization to match comprising:
accessing a web page, wherein the web page comprises an agent;
loading the agent in the background;
generating, with the agent, an agent-generated token in background, and wherein the agent-generated token is encrypted as a cryptographic token;
executing a deep link with the agent-generated token;
sending the agent-generated token, a Universally unique identifier (UUID) and a private key in a hidden native application to an encrypted-token server;
pairing, with the encryption server, the agent-generated token with the UUID;
matching, with the encryption server, the Internet Protocol (IP) address of computing machine implementing the web browser;
determining that the IP address pairs with the agent-generated token;
receiving, with the native application, a call back;
sending the UUID and the agent-generated token back to the encryption server;
receiving, with the encryption server, the UUID and the agent-generated token; and
checking, with the encryption server, that the UUID and the agent-generated token point to same UUID;
determining that the UUID and the agent-generated token point to same UUID.

2. The computerized method of claim 1, wherein the computing device comprises a mobile device.

3. The computerized method of claim 1, wherein the agent comprises a JavaScript file.

4. The computerized method of claim 1, wherein the agent-generated token is an encrypted as a pseudo-random number/character string.

5. The computerized method of claim 1, wherein deep linking comprises the use of a hyperlink that links to a specified searchable and indexed piece of web content on a website and not the website's home page.

6. The computerized method of claim 5,
wherein the hidden native application is installed and operating in the computing device, and
wherein the deep linking trigger the opening of the hidden native application.

7. The computerized method of claim 6, wherein the hidden native'application comprises a hidden mobile device application.

8. The computerized method of claim 7, wherein the web browser requests that an operating system of the computing device open the hidden mobile device application.

9. The computerized method of claim 8, wherein once the hidden native application is opened, the web browser passes the agent-generated token to the native application.

10. The computerized method of claim 9, wherein the step of sending the agent-generated token, a UUID and a private key in the hidden native application to an encrypted-token server further comprises:
sending, with the hidden native application, the agent-generated token, a UUID and a private key in a native application to an encrypted-token server.

11. The computerized method of claim 10, wherein the UUID is embedded in the hidden native application, and wherein the UUID is public.

12. The computerized method of claim 1 further comprising:
verifying a user of the computing device; and
logging in the user.

13. The computerized method of claim 1, wherein the web page is accessed with a web browser of a computing device.
